(19) United States
(12) Patent Application Publication
(10) Pub. No.: US 2020/0059637 A1
(43) Pub. Date: Feb. 20, 2020

(54) THREE-DIMENSIONAL SENSING APPARATUS AND THREE-DIMENSIONAL SENSING METHOD

(71) Applicant: Altek Semiconductor Corp., Hsinchu City (TW)

(72) Inventors: Hong-Long Chou, Hsinchu City (TW); Jye-Sheng Lin, Hsinchu City (TW); Wen-Yan Chang, Hsinchu City (TW)

(73) Assignee: Altek Semiconductor Corp., Hsinchu City (TW)

(21) Appl. No.: 16/505,742

(22) Filed: Jul. 9, 2019

(30) Foreign Application Priority Data
Aug. 17, 2018 (TW) 107128757

(51) Int. Cl. H04N 13/239; G06T 7/593; H04N 5/232

(52) U.S. Cl. CPC H04N 13/239; H04N 2013/0081; H04N 5/23229; G06T 7/593

(57) ABSTRACT

A three-dimensional sensing apparatus including a light-projecting device, at least two image-capture devices, and a processor is provided. The processor is electrically connected to the light-projecting device and the at least two image-capture devices and adapted to provide a control signal to the light-projecting device to adjust the intensity of the illumination beam. The processor adjusts the contrast of the captured image to form a contrast-enhanced image according to a first processing signal and extracts a feature region of the contrast-enhanced image to form a feature-extraction image according to a second processing signal. The processor normalizes the intensity of the feature-extraction image to form an optimized image according to a third processing signal and forms the optimized image into a depth image according to a sensing signal.

### CROSS-REFERENCE TO RELATED APPLICATION

This application claims the priority benefit of Taiwan application serial no. 107128757, filed on Aug. 17, 2018. The entirety of the above-mentioned patent application is hereby incorporated by reference herein and made a part of this specification.

### BACKGROUND OF THE INVENTION

### Field of the Invention

The invention relates to an electronic apparatus and a sensing method, and more particularly, to a three-dimensional sensing apparatus and a three-dimensional sensing method.

### Description of Related Art

In a general three-dimensional sensing technique, passive stereo is the most commonly used method. Through feature comparison and triangulation, depth information can be estimated. However, the accuracy of this method depends on whether the texture of the object to be tested is rich. In general, in low-texture, re-textured scenarios, effective depth information is less likely to be obtained.

In order to solve the above issue, structured light projection can be applied in the three-dimensional sensing technique to facilitate sensing effect. A three-dimensional sensing apparatus based on structured light is composed of one camera device and one projection device. The projection device projects a pre-designed pattern, and an image is taken by the camera device for depth estimation. In general, in order to improve the accuracy of sensing, the projection device is usually composed of a laser diode, a collimating lens, and a diffractive optical element (DOE) via a precision optical design. However, in order to keep the beams in parallel and achieve good optical projection effect, structural complexity is increased, and the difficulty of mass production is significantly increased.

Moreover, the use of a laser diode and a complicated optical system further causes thermal effect issues. Therefore, in order to reduce the influence of thermal effects, an active stereoscopic technique has been proposed. However, this technique still has the issue of being too costly and too complicated in structure to be mass-produced. Therefore, how to design a low-cost, high-precision three-dimensional sensing apparatus capable of mass production and a method thereof is an important topic in the art.

### SUMMARY OF THE INVENTION

The invention provides a three-dimensional sensing apparatus and a three-dimensional sensing method having lower cost and good three-dimensional sensing quality.

An embodiment of the invention provides a three-dimensional sensing apparatus adapted to sense a depth image of a target object. The three-dimensional sensing apparatus includes a light-projecting device, at least two image-capture devices, and a processor. The light-projecting device is adapted to project an illumination beam to the target object. The at least two image-capture devices are adapted to capture a captured image of the target object. The processor is electrically connected to the light-projecting device and the at least two image-capture devices and adapted to provide a control signal to the light-projecting device to adjust the intensity of the illumination beam. The processor adjusts the contrast of the captured image to form a contrast-enhanced image according to a first processing signal. The processor extracts a feature region of the contrast-enhanced image to form a feature-extraction image according to a second processing signal. The processor normalizes the intensity of the feature-extraction image to form an optimized image according to a third processing signal. The processor forms the optimized image into the depth image according to a sensing signal.

In an embodiment of the invention, the light-projecting device includes a light-emitting element and a projecting element. The light-emitting element is adapted to emit the illumination beam. The projecting element is disposed on the transmission path of the illumination beam and adapted to allow the illumination beam to pass through and diverge the illumination beam.

In an embodiment of the invention, the light-emitting element is a light-emitting diode.

Another embodiment of the invention provides a three-dimensional sensing apparatus adapted to sense a depth image of a target object. The three-dimensional sensing apparatus includes a light-projecting device, at least two image-capture devices, and a processor. The light-projecting device is adapted to project an illumination beam to the target object. The at least two image-capture devices are adapted to capture a captured image of the target object. The processor is electrically connected to the light-projecting device and the at least two image-capture devices and adapted to provide a control signal to the light-projecting device to adjust the intensity of the illumination beam. The processor adjusts the captured image to form an optimized image according to a processing signal and forms the optimized image into the depth image according to a sensing signal.

In an embodiment of the invention, the light-projecting device includes a light-emitting element and a projecting element. The light-emitting element is adapted to emit the illumination beam. The projecting element is disposed on the transmission path of the illumination beam and adapted to allow the illumination beam to pass through and diverge the illumination beam.

In an embodiment of the invention, the light-emitting element is a light-emitting diode.

In an embodiment of the invention, the processor is adapted to provide a control signal to the light-projecting device to adjust the intensity of the illumination beam.

In an embodiment of the invention, the processing signal includes a first processing signal, a second processing signal, and a third processing signal, and the processor is configured to: adjust the contrast of the captured image to form a contrast-enhanced image according to the first processing signal; extract a feature region of the contrast-enhanced image to form a feature-extraction image according to the second processing signal; and normalize the intensity of the feature-extraction image to form an optimized image according to the third processing signal.

Another embodiment of the invention provides a three-dimensional sensing apparatus adapted to sense a depth image of a target object. The three-dimensional sensing apparatus includes a light-projecting device and at least two image-capture devices. The light-projecting device is adapted to project an illumination beam to the target object. The light-projecting device includes a light-emitting element and a projecting element. The light-emitting element is adapted to emit the illumination beam. The projecting element is disposed on the transmission path of the illumination beam and adapted to allow the illumination beam to pass through and diverge the illumination beam. The at least two image-capture devices are adapted to capture a captured image of the target object to form a depth image.

In an embodiment of the invention, the light-emitting element is a light-emitting diode.

In an embodiment of the invention, the three-dimensional sensing apparatus further includes a processor electrically connected to the light-projecting device and the at least two image-capture devices.

In an embodiment of the invention, the processor adjusts the captured image to form the optimized image according to a processing signal and forms the optimized image into the depth image according to a sensing signal.

In an embodiment of the invention, the processing signal includes a first processing signal, a second processing signal, and a third processing signal, and the processor is configured to: adjust the contrast of the captured image to form a contrast-enhanced image according to the first processing signal; extract a feature region of the contrast-enhanced image to form a feature-extraction image according to the second processing signal; and normalize the intensity of the feature-extraction image to form an optimized image according to the third processing signal.

Another embodiment of the invention provides a three-dimensional sensing method adapted to sense a target object, including the following steps. A three-dimensional sensing apparatus is provided, including a light-projecting device, at least two image-capture devices, and a processor electrically connected to the light-projecting device and the at least two image-capture devices. An illumination beam is provided to the target object. An image performance of the target object is captured to form a captured image. The captured image is adjusted to form an optimized image according to a processing signal. The optimized image is formed into a depth image according to a sensing signal.

In an embodiment of the invention, the light-projecting device includes a light-emitting element and a projecting element, wherein the light-emitting element is adapted to emit an illumination beam, and the projecting element is disposed on the transmission path of the illumination beam to allow the illumination beam to pass through and diverge.

In an embodiment of the invention, the light-emitting element is a light-emitting diode.

In an embodiment of the invention, the processing signal includes a first processing signal, a second processing signal, and a third processing signal, and the method of adjusting the captured image to form the optimized image according to the processing signal includes the following steps. The contrast of the captured image is adjusted to form a contrast-enhanced image according to the first processing signal. A feature region of the contrast-enhanced image is extracted to form a feature-extraction image according to the second processing signal. The intensity of the feature-extraction image is normalized to form the optimized image according to the third processing signal.

Based on the above, in the three-dimensional sensing apparatus and the three-dimensional sensing method of the invention, the three-dimensional sensing apparatus includes a simple light-projecting device, and a captured image is obtained via the irradiation of the light-projecting device and the at least two image-capture devices. Therefore, the processor can perform an image processing procedure on the captured image to obtain an optimized image according the processing signal, so as to perform sensing to form a depth image having three-dimensional information.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of a three-dimensional sensing apparatus according to an embodiment of the invention.

FIG. 2 is a schematic of a three-dimensional sensing apparatus according to another embodiment of the invention.

FIG. 3 is a schematic of the light-projecting device of FIG. 1.

FIG. 4 is a flowchart of a three-dimensional sensing method according to an embodiment of the invention.

FIG. 5 is a flowchart of a three-dimensional sensing method according to another embodiment of the invention.

### DESCRIPTION OF THE EMBODIMENTS

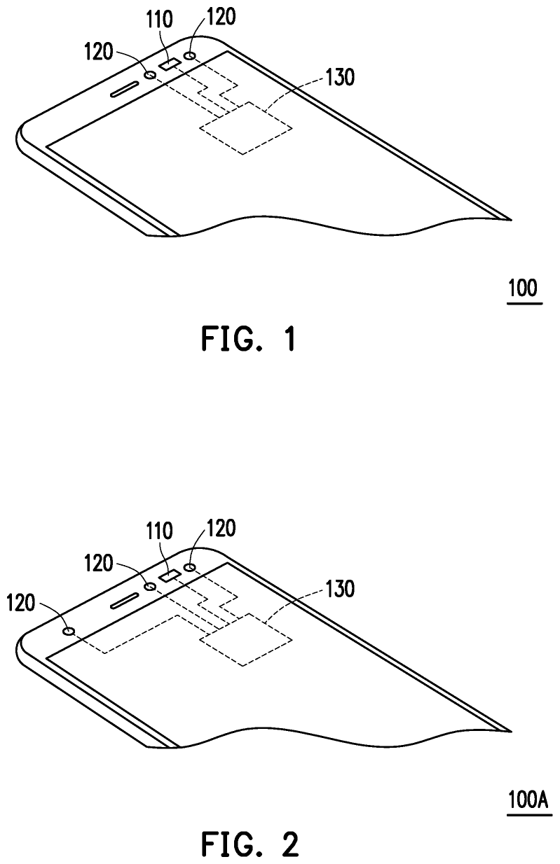

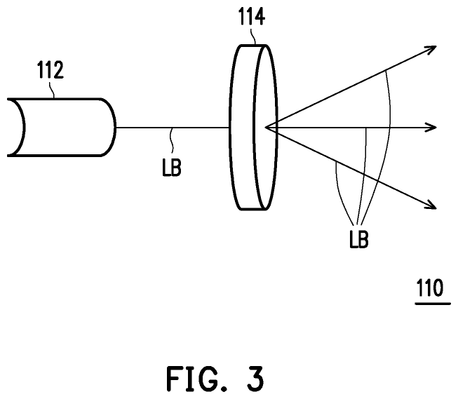

FIG. 1 is a schematic of a three-dimensional sensing apparatus according to an embodiment of the invention. In the present embodiment, a three-dimensional sensing apparatus 100 is adapted to sense a depth image of a target object (not shown). The three-dimensional sensing apparatus 100 includes a light-projecting device 110, at least two image-capture devices 120, and a processor 130. In the present embodiment, the three-dimensional sensing apparatus 100 projects an illumination beam (see an illumination beam LB of FIG. 3) to the target object via the light-projecting device 110, and then captures an image performance of the target object via the image-capture devices 120 to form a captured image. Lastly, the processor 130 is used to perform image processing to form an optimized image capable of three-dimensional sensing, thereby obtaining a depth image to complete three-dimensional sensing.

In the present embodiment, the number of the image-capture devices 120 is, for instance, two, but the invention is not limited thereto. Moreover, in the present embodiment, the image-capture devices 120 can be, for instance, mono image-capture devices, color image-capture devices, mono-IR image-capture devices, red-green-blue-infrared (RGB-IR) image-capture devices, infrared (IR) image-capture devices, or any combination of the above, but the invention is not limited thereto. In other words, in the present embodiment, the at least two image-capture devices 120 can be configured as different types to perform different image capture or sensing to achieve different effects and functions, but the present invention is not limited thereto.

FIG. 2 is a schematic of a three-dimensional sensing apparatus according to another embodiment of the invention. Referring to FIG. 2, a three-dimensional sensing apparatus 100A of the present embodiment is similar to the three-dimensional sensing apparatus 100 of FIG. 1. The difference between the two is that the number of the image-capture devices 120 in the present embodiment is three, and the three image-capture devices 120 can have different functions depending on the type. In some embodiments, the number of the image-capture devices 120 can be configured to be three or more as needed, but the invention is not limited thereto.

FIG. 3 is a schematic of the light-projecting device of FIG. 1. Referring to FIG. 1 and FIG. 3, in the present embodiment, the light-projecting device 110 includes a light-emitting element 112 and a projecting element 114. The light-emitting element 112 is adapted to emit the illumination beam LB. In the present embodiment, the light-emitting element 112 adopts, for instance, a light-emitting diode (LED) or other simple light-emitting elements. The projecting element 114 is disposed on the transmission path of the illumination beam LB and adapted to allow the illumination beam LB to pass through and diverge the illumination beam LB. The projecting element 114 adopts an optical element such as a diffractive optical element (DOE) or the like capable of generating patterned light or structured light, such that the illumination beam LB passes through to generate patterned light or structured light and is divergently transmitted. In other words, in the present embodiment, the illumination beam LB capable of three-dimensional sensing is formed by naturally diverging the light emitted by the light-emitting element 112 and transmitted through the projecting element 114.

Specifically, in the present embodiment, a laser source and a complicated optical system are omitted as compared with a conventional method. In the present embodiment, only the simple light-emitting element 112 is used to emit the illumination beam LB and a patterned light or structured light is generated by a single projecting element 114 to be projected to the target object, and then a screen is captured by two or more of the image-capture devices 120 from different angles to perform a subsequent image processing procedure to complete the three-dimensional sensing. As a result, a sensing effect the same as or better than the traditional architecture can be achieved by a simple projection architecture, thereby simplifying the light-projecting device 110 architecture and saving cost, and the light-projecting device 110 can be easy to mass-produce.

Referring further to FIG. 1 and FIG. 3, the processor 130 is electrically connected to the light-projecting device 110 and the at least two image-capture devices 120 and adapted to provide a control signal to the light-projecting device 110 to adjust the intensity of the illumination beam LB and control the at least two image-capture devices 120 to capture a screen of a target object to obtain a captured image. Moreover, the obtained captured image is further subjected to an image processing procedure to obtain an optimized image for three-dimensional sensing. In some embodiments, the three-dimensional sensing apparatus 100 can further configure the sensing element and be electrically connected to the processor 130. At this point, a feedback can be provided to the processor 130 using the light intensity sensed by the sensing element to further correct the intensity of the illumination beam LB, but the invention is not limited thereto.

In the image processing procedure of the present embodiment, the processor 130 adjusts the captured image to form the optimized image according to a processing signal, and senses the optimized image to form a depth image according to a sensing signal. For instance, in the present embodiment, the processing signal includes a first processing signal, a second processing signal, and a third processing signal, and the processor 130 adjusts the contrast of the captured image to form a contrast-enhanced image according to the first processing signal. As a result, the contrast-enhanced image has better contrast than the captured image, and better sensing effect can further be obtained.

Moreover, the processor 130 can extract a feature region of the contrast-enhanced image to form a feature-extraction image according to the second processing signal. As a result, image optimization can be further performed on a region with less depth variation such that the subsequent three-dimensional sensing has better sensing effect. Furthermore, the processor 130 can normalize the intensity of the feature-extraction image to form an optimized image according to the third processing signal. As a result, the distortion of the image can be further reduced to improve the subsequent three-dimensional sensing accuracy.

After the image processing procedure of the present embodiment is completed, the processor 130 can form the optimized image into a depth image according to a sensing signal. Specifically, the three-dimensional sensing apparatus 100 can perform three-dimensional sensing on the optimized image obtained via the processor 130 to obtain a depth image having three-dimensional information to complete the three-dimensional sensing. In some embodiments, the processing signal can include only the first processing signal, the second processing signal, or the third processing signal or any combination of the processing signals for the image processing procedure. In other words, the user can adjust the combination of the processing signals as needed to allow the processor 130 to perform the image processing procedure. As a result, the three-dimensional sensing freedom of the three-dimensional sensing apparatus 100 can be increased and the three-dimensional sensing apparatus 100 can be adapted to various different types of target objects, but the invention is not limited thereto.

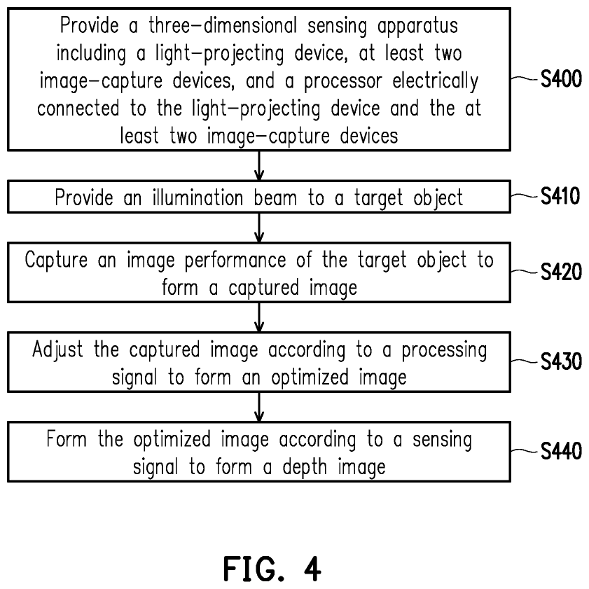

FIG. 4 is a flowchart of a three-dimensional sensing method according to an embodiment of the invention. The three-dimensional sensing method of the present embodiment is adapted to at least the three-dimensional sensing apparatus 100 of FIG. 1 or the three-dimensional sensing apparatus 100A of FIG. 2, and the three-dimensional sensing apparatus 100 of FIG. 1 is exemplified in the following, but the invention is not limited thereto. Referring to FIG. 1, FIG. 3, and FIG. 4 simultaneously, in the three-dimensional sensing method of the present embodiment, first, step S400 is performed to provide a three-dimensional sensing apparatus 100 including a light-projecting device 110, at least two image-capture devices 120, and a processor 130 electrically connected to the light-projecting device 110 and the at least two image-capture devices 120. Next, step S410 is performed to provide an illumination beam LB to a target object. Specifically, in this step, the illumination beam LB is generated by the light-projecting device 110 and the illumination beam LB is projected to the target object to generate an image performance that can be captured by the at least two image-capture devices 120.

Then, step S420 is performed to capture the image performance of the target object to form a captured image. Specifically, in this step, a screen of the target object is captured and the screen is integrated into the captured image using the at least two image-capture devices 120 for subsequent image processing. Then, step S430 is performed to adjust the captured image to form an optimized image according to a processing signal. Specifically, in this step, an image processing procedure is performed on the captured image using the processor 130 to obtain an optimized image capable of three-dimensional sensing. Lastly, step S440 is performed to form the optimized image into a depth image according to a sensing signal to complete the three-dimensional sensing.

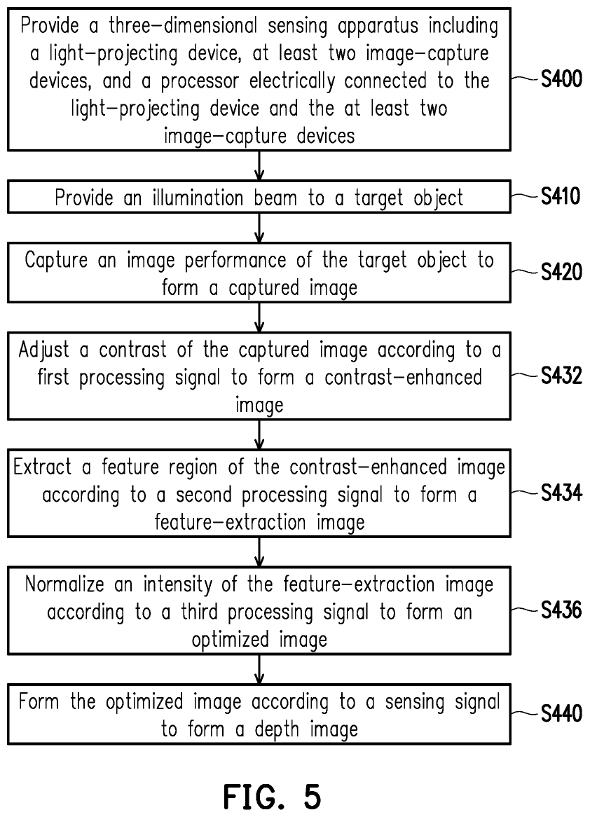

FIG. 5 is a flowchart of a three-dimensional sensing method according to another embodiment of the invention. The three-dimensional sensing method of the present embodiment is adapted to at least the three-dimensional sensing apparatus 100 of FIG. 1 or the three-dimensional sensing apparatus 100A of FIG. 2, and the three-dimensional sensing apparatus 100 of FIG. 1 is exemplified in the following, but the invention is not limited thereto. Referring to FIG. 1, FIG. 3, and FIG. 5 simultaneously, the three-dimensional sensing method of the present embodiment is similar to the three-dimensional sensing method of FIG. 4, and the difference between the two is that the processing signal of the present embodiment includes the first processing signal, the second processing signal, and the third processing signal, and the method of adjusting the captured image to form the optimized image according to the processing signal includes: performing step S432 to adjust the contrast of the captured image to form a contrast-enhanced image according to the first processing signal; performing step S434 to extract a feature region of the contrast-enhanced image to form a feature-extraction image according to the second processing signal; and performing step S436 to normalize the intensity of the feature-extraction image to form the optimized image according to the third processing signal. In particular, sufficient implication regarding the detailed steps and methods for obtaining the contrast-enhanced image, the feature-extraction image, and the optimized image can be obtained from the above description, which are not repeated herein.

Based on the above, in the three-dimensional sensing apparatus and the three-dimensional sensing method of the invention, the three-dimensional sensing apparatus includes a simple light-projecting device and a captured image is obtained via the irradiation of the light-projecting device and the at least two image-capture devices. As a result, the processor can perform an image processing procedure on the captured image to obtain an optimized image according to the processing signal so as to perform sensing to form a depth image having three-dimensional information.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A three-dimensional sensing apparatus adapted to sense a depth image of a target object, comprising:
a light-projecting device adapted to project an illumination beam to the target object;
at least two image-capture devices adapted to capture a captured image of the target object; and
a processor electrically connected to the light-projecting device and the at least two image-capture devices and adapted to provide a control signal to the light-projecting device to adjust an intensity of the illumination beam, wherein the processor adjusts a contrast of the captured image to form a contrast-enhanced image according to a first processing signal, the processor extracts a feature region of the contrast-enhanced image to form a feature-extraction image according to a second processing signal, the processor normalizes an intensity of the feature-extraction image to form an optimized image according to a third processing signal, and the processor forms the optimized image into the depth image according to a sensing signal.

2. The three-dimensional sensing apparatus of claim 1, wherein the light-projecting device comprises:
a light-emitting element adapted to emit the illumination beam; and
a projecting element disposed on a transmission path of the illumination beam and adapted to allow the illumination beam to pass through and diverge the illumination beam.

3. The three-dimensional sensing apparatus of claim 2, wherein the light-emitting element is a light-emitting diode.

4. A three-dimensional sensing apparatus adapted to sense a depth image of a target object, comprising:
a light-projecting device adapted to project an illumination beam to the target object;
at least two image-capture devices adapted to capture a captured image of the target object; and
a processor electrically connected to the light-projecting device and the at least two image-capture devices, wherein the processor adjusts the captured image to form the optimized image according to a processing signal, and forms the optimized image into the depth image according to a sensing signal.

5. The three-dimensional sensing apparatus of claim 4, wherein the light-projecting device comprises:
a light-emitting element adapted to emit the illumination beam; and
a projecting element disposed on a transmission path of the illumination beam and adapted to allow the illumination beam to pass through and diverge the illumination beam.

6. The three-dimensional sensing apparatus of claim 5, wherein the light-emitting element is a light-emitting diode.

7. The three-dimensional sensing apparatus of claim 4, wherein the processor is adapted to provide a control signal to the light-projecting device to adjust an intensity of the illumination beam.

8. The three-dimensional sensing apparatus of claim 4, wherein the processing signal comprises a first processing signal, a second processing signal, and a third processing signal, and the processor is configured to:
adjust a contrast of the captured image to form a contrast-enhanced image according to the first processing signal;
extract a feature region of the contrast-enhanced image to form a feature-extraction image according to the second processing signal; and
normalize an intensity of the feature-extraction image to form an optimized image according to the third processing signal.

9. A three-dimensional sensing apparatus adapted to sense a depth image of a target object, comprising:
a light-projecting device adapted to project an illumination beam to the target object, the light-projecting device comprising:
a light-emitting element adapted to emit the illumination beam; and
a projecting element disposed on a transmission path of the illumination beam and adapted to allow the illumination beam to pass through and diverge the illumination beam; and
at least two image-capture devices adapted to capture a captured image of the target object to form the depth image.

10. The three-dimensional sensing apparatus of claim 9, wherein the light-emitting element is a light-emitting diode.

11. The three-dimensional sensing apparatus of claim 9, further comprising:
a processor electrically connected to the light-projecting device and the at least two image-capture devices.

12. The three-dimensional sensing apparatus of claim 11, wherein the processor adjusts the captured image to form the optimized image according to a processing signal and forms the optimized image into the depth image according to a sensing signal.

13. The three-dimensional sensing apparatus of claim 11, wherein the processing signal comprises a first processing signal, a second processing signal, and a third processing signal, and the processor is configured to:
adjust a contrast of the captured image to form a contrast-enhanced image according to the first processing signal;
extract a feature region of the contrast-enhanced image to form a feature-extraction image according to the second processing signal; and
normalize an intensity of the feature-extraction image to form an optimized image according to the third processing signal.

14. A three-dimensional sensing method adapted to sense a target object, comprising:
providing a three-dimensional sensing apparatus comprising a light-projecting device, at least two image-capture devices, and a processor electrically connected to the light-projecting device and the at least two image-capture devices;
providing an illumination beam to the target object;
capturing an image performance of the target object to form a captured image;
adjusting the captured image to form an optimized image according to a processing signal; and
forming the optimized image into the depth image according to a sensing signal.

15. The three-dimensional sensing method of claim 14, wherein the light-projecting device comprises a light-emitting element and a projecting element, wherein the light-emitting element is adapted to emit the illumination beam, and the projecting element is disposed on a transmission path of the illumination beam to allow the illumination beam to pass through and diverge.

16. The three-dimensional sensing method of claim 15, wherein the light-emitting element is a light-emitting diode.

17. The three-dimensional sensing method of claim 14, wherein the processing signal comprises a first processing signal, a second processing signal, and a third processing signal, and a method of adjusting the captured image to form the optimized image according to the processing signal comprises:
adjusting a contrast of the captured image to form a contrast-enhanced image according to the first processing signal;
extracting a feature region of the contrast-enhanced image to form a feature-extraction image according to the second processing signal; and
normalizing an intensity of the feature-extraction image to form the optimized image according to the third processing signal.
